(19) United States
(12) Patent Application Publication
(10) Pub. No.: US 2020/0148906 A1
(43) Pub. Date: May 14, 2020

(54) PRINT SUBSTRATE PRE-TREATMENT

(71) Applicant: HEWLETT-PACKARD DEVELOPMENT COMPANY, L.P., Spring, TX (US)

(72) Inventors: Marta BLANCH PIÑOL, Sant Cugat del Valles (ES); Cristina CRESPI, Sant Cugat del Valles (ES); Jennifer KORNGIEBEL, San Diego, CA (US)

(21) Appl. No.: 16/473,589

(22) PCT Filed: Apr. 17, 2017
(86) PCT No.: PCT/US2017/027951

§ 371 Date: Jun. 25, 2019

(51) Int. Cl. C09D 11/322; B41J 2/21; C09D 11/10; C09D 11/54

(52) U.S. Cl. CPC C09D 11/322; C09D 11/54; C09D 11/10; B41J 2/2114

(57) ABSTRACT

A method, in a printing system comprising a carriage that includes a first print head for depositing a first print fluid on a substrate and a second print head for depositing a second print fluid on the substrate, in which the method comprises using the second print head, pre-treating the substrate to obstruct print fluid migration into a porous structure of the substrate by depositing a post-print-treatment fluid over at least a portion of the substrate prior to deposition of the first print fluid on the substrate.

### BACKGROUND

A printing apparatus, such as an ink jet printer for example, can be used to print on many different types of media. Multiple print heads can be used to deposit print fluids, such as ink, to the media and post-treatment liquids can then be deposited to provide a desired effect, such as a glossy appearance for example.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1a is a schematic representation of a printing system according to an example;

FIG. 1b is a schematic representation of a printing apparatus according to an example;

FIG. 1c is a schematic representation of a print mode layout according to an example;

FIG. 2a is a schematic representation of a method according to an example; and

FIG. 2b is a schematic representation of a method according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In the context of a hybrid printing apparatus, which can be used to print on many different types of media, the printing strategy can be adapted in order to have a wider range of media supported. For example, when using some cellulosic medias, a primer treatment can be applied before printing. In order to pre-treat such media, additional hardware can be used or pre-processing steps can be carried out. In either case, application of the primer reduces throughput.

According to an example, there is provided a method, in a print process utilising cellulosic media in which, prior to print fluid, such as ink, deposition, a primer is applied. More particularly, and to maintain throughput, a non-utilised print head position in the carriage of a printing apparatus can be used as the source for a primer to be deposited to the media during the print process. In an example, the primer is a post-treatment liquid. That is, in an example, a print fluid used for post-treatment following ink deposition is used as a pre-treatment using a print head pocket housing a print head not used for the media in question.

The application of a post-treatment prior to printing closes or reduces the effects of a porous surface of cellulosic media. This supports polymerization of, for example, latex based print fluids, aids curing and increases durability. More specifically, a latex based print fluid can achieve its image quality and durability potential when it polymerizes to form a uniform layer or film that gives a characteristic glossy appearance. In a cellulosic media, or more generally any type of porous media, print fluid particles, such as pigment, latex and waxes and so on, can penetrate the surface of the media once deposited. In fact, the particles wick into the media pore matrix and have different penetration rates. This can cause the print fluid components to separate once deposited. For example, a solvent material can wick into the media pore matrix away from latex and pigment particles.

For polymerization to occur, latex particles should remain close together on the surface of the substrate in the presence of solvents. However, as noted, due to the porous nature of cellulosic substrates, the print fluid can penetrate into the fibre matrix. The particles of the fluid formulation penetrate differently due to their different size and due to the non-homogeneity of the matrix itself. The solvent also wicks into the matrix, away from latex, increasing the minimum film forming temperature (MFFT) of the latex which can result in curing defects thereby spoiling the appearance of a finished article.

According to an example, application or deposition of a fluid layer prior to ink deposition is used to close or reduce the effects of a porous matrix of a print medium. In an example in which a latex-based ink formulation is used, this can facilitate polymerization thereby enabling curing and increasing durability. The process described herein may be used with other print fluids where reducing the effects of or closing the pores of a porous media can increase the quality of a final printed article.

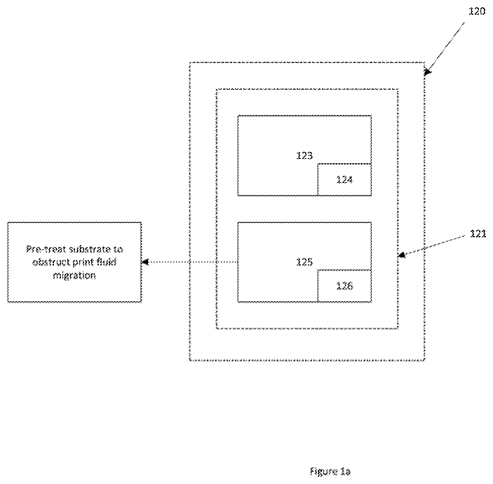

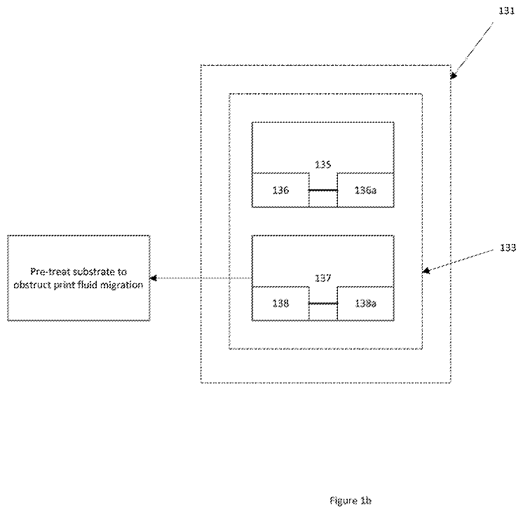

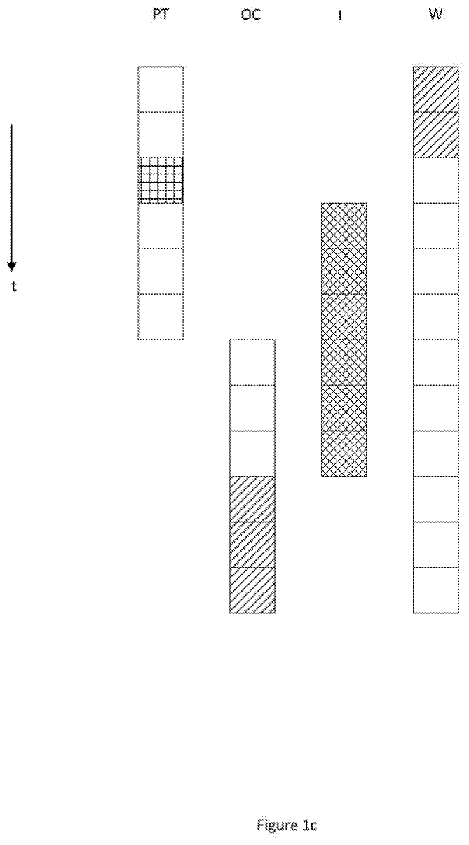

FIG. 1a is a schematic representation of a printing system according to an example. The printing system 120 of FIG. 1, such as an ink jet printing apparatus for example, comprises a carriage 121 that includes a first print head 123 for depositing a first print fluid 124, such as a latex-based ink, on a substrate (not shown), which can be a cellulosic structure or medium with a porous structure for example, and a second print head 125 for depositing a second print fluid 126 on the substrate. In an example, the second print head 125 can be used to pre-treat the substrate to obstruct print fluid migration into the porous structure of the substrate by depositing a post-print-treatment fluid over at least a portion of the substrate prior to deposition of the first print fluid 124 on the substrate.

FIG. 1b is a schematic representation of a printing apparatus according to an example. The ink jet printing apparatus 131 comprises a carriage system 133 that includes print head pockets 135, 137 to receive a first print head 136 for depositing a first print fluid 136a on a substrate and a second print head 138 for depositing a second print fluid 138a on the substrate, wherein the second print head 138 is configured to deposit a post-print-treatment fluid 138a prior to deposition of the first print fluid 136a on the substrate to form a pre-treatment for the substrate to obstruct print fluid migration into a porous structure of the substrate. In the example of FIG. 1b, the second print head 138 is located in a print head pocket 137 of the ink jet printing apparatus 131 that is not utilised for deposition of an ink fluid for the substrate.

In an example, in which a cellulosic medium is to be printed on, it can be the case that white pigment based print fluid (such as ink) is not used because of its applications and the cost. That is, for use on cellulosic or other porous materials for example, white (and indeed other light colored print fluids) may not be utilised. Therefore, in an example, the carriage layout of the printing apparatus can be reused such that a print head used to deposit white (or another light colored) print fluid is used to deposit a primer fluid while printing.

According to an example, a print fluid used as an overcoat that is deposited post-print to improve scratch resistance can be used as a pre-print-treatment as a cellulosic primer. Such an overcoat can provide a uniform film that acts as an impermeable layer, thereby producing a mechanical barrier which prevents or reduces print fluid penetration into the porous matrix of a substrate.

Reusing the print carriage layout of a printing apparatus in this way enables the flexibility of being able to print an ink (such as white for example) or a pre-treatment (primer) since all of the print fluid supply pipework and the hardware is the same. In an example, the supplies and a selected print head can be changed in order to enable the primer to be deposited. Thus, once printing is executed, a modified print process can be selected in the internal print server (IPS) using a specific media profile. In an example, such a media profile can include information relating to the adapted pipeline and print mode so as to enable the apparatus to deposit the primer before any ink or other pre-treatments are deposited using the other print heads.

For example, using a white print head pocket, a notional white plane of an image to be printed can comprise the information for a primer plane to be applied. The print mode can utilise an underflood layout in which the primer is deposited over a least a region of the medium being printed on and thereafter a normal printing process can be executed (for example, pre-treatment for inks, deposition of colors using inks, deposition of overcoat and so on). Such image and print mode adjustments can, in an example, be selected as part of a media profile selection process.

Thus, according to an example, improved film formation via increased latex particle density and increased solvent/latex concentration in an applied liquid surface layer is provided. This can result in increased print durability as well as improved color consistency between various porous media, improved color gamut, chroma and saturation.

As a print head pocket that would otherwise not be utilised in a print process is used to deposit a pre-treatment, print throughput is unaffected because the printing apparatus can still use the full swath of other colors. The use of an overcoat fluid as a primer for porous media means that additional fluids or printer accessories are unnecessary.

Accordingly, a non-utilised print head pocket of a printing apparatus or system can be re-tasked to enable a print fluid that is used as a post-print treatment to be applied as a -pre-print treatment.

FIG. 1c is a schematic representation of a print mode layout according to an example. In the example of FIG. 1, PT=pre-treatment process, OC=overcoat process, I=Image print (ink) process and W indicates the use of the re-purposed print head pocket for a pre-treatment process. Empty boxes represent a time (t) when there is no activity for the process in question. Boxes with hatching represent activity for the part of the process in question. Thus, initially, a primer is applied using the print head pocket that would otherwise have been used for an ink deposition. Thereafter, a pre-treatment process occurs, followed by an image print process (ink deposition), and finally an overcoating process is executed. As shown in FIG. 1, the pre-treatment and over coat process use the same material (depicted by the same hatching), although different print heads are used.

Without pre-treatment using an overcoat material as described above prints suffer from various artefacts such as patches of gloss mottle or burnishing defects as a result of the print fluid particles wicking into the porous media substrate. In an example, application of 0.5 drops per pixel (dpp) of an overcoat reduces burnishing to low ink density areas and positive results are achieved at high ink density areas. When 1 dpp of an overcoat underflood is applied, burnishing is reduced even further and the quality in high ink density areas is further improved. More or less drops per pixel may be applied depending on the circumstances, such as the type of media in use and the desired level of pore blocking.

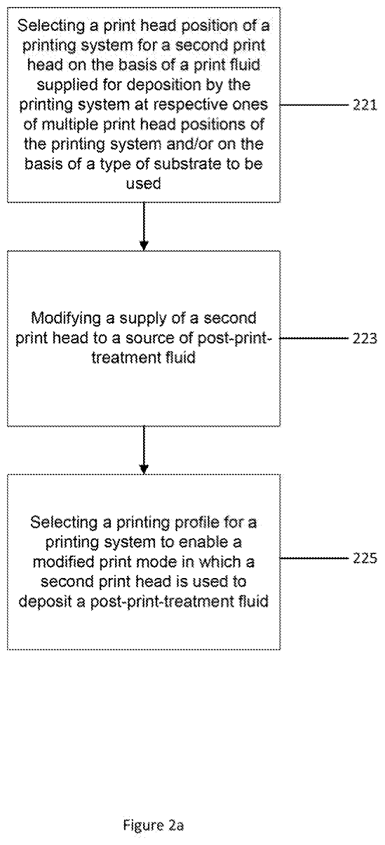

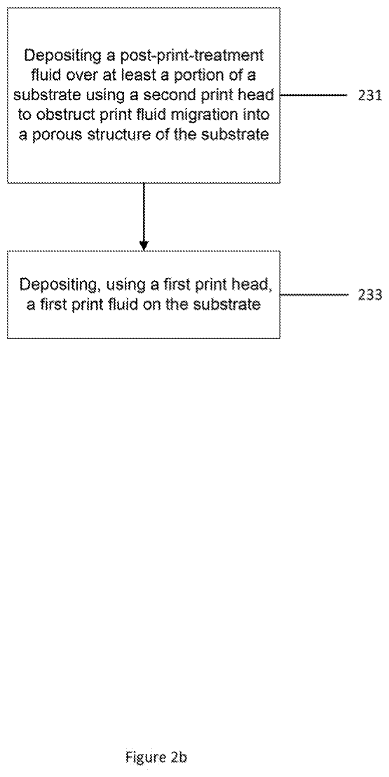

FIG. 2a is a schematic representation of a method according to an example. In block 221, a print head position of a printing system for a second print head is selected on the basis of a print fluid supplied for deposition by the printing system at respective ones of multiple print head positions of the printing system and/or on the basis of a type of substrate to be used. For example, for a cellulosic media, a print head position that is used for white or a light colored print fluid (such as ink) can be selected. In block 223, a supply of the second print head is modified to a source of post-print-treatment fluid. For example, the supply can be modified to supply a post-treatment overcoat. In block 225, a printing profile for a printing system is selected to enable a modified print mode in which the second print head is used to deposit the post-print-treatment fluid.

FIG. 2b is a schematic representation of a method according to an example. In block 231, a post-print-treatment fluid is deposited over at least a portion of a substrate using a second print head, whereby to obstruct print fluid migration into a porous structure of the substrate. For example, the overcoat is deposited to block, clog, fill or otherwise reduce the effects of pores in the substrate. In block 233, a first print fluid, such as ink for example, is deposited using a first print head.

Accordingly, a print head pocket that would otherwise remain unutilised in a print job can be re-tasked to enable a post-print-treatment fluid to be applied to a substrate before ink (or other pre-treatment) deposition.

According to an example, a reactive pre-treatment (PT) fluid may be redundant as the processes described herein have utility independent of the presence of a reactive PT fluid. Other printing systems with a clear fluid that has pore-blocking capability could use the processes described herein, regardless of whether a PT fluid is used.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, in a printing system comprising a carriage that includes a first print head for depositing a first print fluid on a substrate and a second print head for depositing a second print fluid on the substrate, the method comprising:
using the second print head, pre-treating the substrate to obstruct print fluid migration into a porous structure of the substrate by depositing a post-print-treatment fluid over at least a portion of the substrate prior to deposition of the first print fluid on the substrate.

2. The method of claim 1, comprising:
modifying a supply of the second print head to a source of the post-print-treatment fluid.

3. The method of claim 1, comprising:
selecting a printing profile for the printing system to enable a modified print mode in which the second print head is used to deposit the post-print-treatment fluid.

4. The method of claim 3, wherein selecting a printing profile includes selecting a media profile representing the substrate.

5. The method of claim 1, comprising:
selecting a print head position of the printing system for the second print head based on a type of substrate to be used.

6. The method of claim 1, further comprising:
selecting a print head position of the printing system for the second print head based on a print fluid supplied for deposition by the printing system at respective ones of multiple print head positions of the printing system.

7. The method of claim 1, wherein the first print fluid is an ink fluid comprising particles of at least one pigment and latex.

8. The method of claim 1, comprising:
depositing a pre-treatment on at least a portion of the substrate;
depositing at least one colored print fluid on at least a portion of the substrate; and
depositing an overcoat on at least a portion of the substrate.

9. The method of claim 1, comprising:
depositing 0.50-1.50 dots per pixel of the post-print-treatment fluid.

10. The method of claim 1, comprising:
swapping an existing print head of the printing system with the second print head.

11. A printing system comprising:
a carriage that includes a first print head for depositing a first print fluid on a substrate and a second print head for depositing a second print fluid on the substrate,
wherein the second print head is to deposit a post-print-treatment fluid prior to deposition of the first print fluid on the substrate to form a pre-treatment for the substrate to obstruct print fluid migration into a porous structure of the substrate.

12. The printing system of claim 11, wherein the post-print-treatment fluid is an overcoat fluid.

13. The printing system of claim 11, wherein the second print head is located in a print head pocket of the printing system that is not utilised for deposition of an ink fluid for the substrate.

14. An ink jet printing apparatus comprising:
a carriage system that includes print head pockets to receive a first print head for depositing a first print fluid on a substrate and a second print head for depositing a second print fluid on the substrate,
wherein the second print head is to deposit a post-print-treatment fluid prior to deposition of the first print fluid on the substrate to form a pre-treatment for the substrate to obstruct print fluid migration into a porous structure of the substrate.

15. The printing system of claim 14, wherein the second print head is located in a print head pocket of the ink jet printing apparatus that is not utilised for deposition of an ink fluid for the substrate.
